(19) United States
(12) Patent Application Publication
(10) Pub. No.: US 2015/0212243 A1
(43) Pub. Date: Jul. 30, 2015

(54) SPORTS EQUIPMENT HAVING REFLECTIVE COATING

(71) Applicant: Nike, Inc., Beaverton, OR (US)

(72) Inventor: Andrew G.V. Oldknow, Portland, OR (US)

(73) Assignee: Nike, Inc., Beaverton, OR (US)

(21) Appl. No.: 14/163,613

(22) Filed: Jan. 24, 2014

(51) Int. Cl. G02B 5/136; G02B 5/128; G02B 5/13; A63B 55/00

(52) U.S. Cl. CPC G02B 5/136; A63B 55/007; A63B 55/008; G02B 5/128; G02B 5/13

(57) ABSTRACT

The present invention relates to an article of sports equipment including a retroreflective material on an exterior surface of the sports equipment. The retroreflective material may be engaged with or integrally formed with the exterior surface and is at least partially visible on the exterior surface of the sports equipment. The retroreflective material may reflect light and provide a desired visual appearance. The present invention provides a unique aesthetic display with marketing and advertising appeal. The present invention also may aid in the identification of ownership of sports equipment.

### TECHNICAL FIELD

The invention relates generally to sports equipment, and more specifically, to sports equipment having reflective material thereon to provide a desired visual appearance.

### BACKGROUND

Sports equipment may have designs or logos on its exterior surface, thereby providing aesthetic appeal, identification means, and/or marketing means. Although such designs may exist on sports equipment, the designs are typically conventional and are accomplished by information/markings that retain a constant visual appearance, such as paint, dye, ink, stitching, patches, etc. Certain parties, such as manufacturers, sponsors, etc., may wish for logos, advertisements, and other indicia associated with them to be highly visible, particularly when they are on equipment used by professional athletes, of whom many photos are often taken and published. However, athletes may find highly visible indicia to be aesthetically unappealing, distracting, or otherwise undesirable. Accordingly, a need exists for equipment that is desirable for all parties involved. Additionally, it may be aesthetically desirable for the user and/or other parties such as manufacturers, sponsors, etc., to have sports equipment that presents different visual appearances in different lighting conditions and provides other unique visual appearances.

Accordingly, it can be appreciated that there still exists a need for sports equipment having a design which is aesthetically pleasing, provides marketing opportunity, and/or aids sports equipment identification. It is, therefore, desirable to provide cost-efficient designs that are unique and appealing to consumers, as well as manufacturers, sponsors, etc. The present disclosure is provided to address the problems discussed above and other problems, and to provide advantages and aspects not provided by prior designs of this type. A full discussion of the features and advantages of the present invention is deferred to the following detailed description, which proceeds with reference to the accompanying drawings.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of the invention relate to an article of sports equipment including a body having an exterior surface. A retroreflective material is connected to the body and at least partially visible on the exterior surface of the body. The retroreflective material is configured to create a different visual appearance from other portions of the exterior surface of the body when exposed to a light source.

According to one aspect, the retroreflective material is visible on at least thirty percent of the exterior surface. In other aspects, the retroreflective material is visible on at least fifty percent of the exterior surface.

According to another aspect, the body includes a matte portion. The matte portion is at least partially visible on the exterior surface of the body.

According to a further aspect, the retroreflective material forms a pattern graphic. In other aspects, the retroreflective material forms human-readable indicia.

According to a further aspect, the retroreflective material is removable from the sports equipment.

According to a further aspect, the retroreflective material reflects at least light of high intensity.

According to a further aspect, the light of high intensity is selected from a group consisting of: a camera flash, a camera light, and a flashlight.

According to a further aspect, the retroreflective material is a sheet material comprising a plurality of retroreflective bodies sealed onto a base sheet layer.

According to a further aspect, the retroreflective bodies include at least one type selected from a group consisting of: retroreflective glass beads, microprisms, and encapsulated lenses.

According to a further aspect, the retroreflective material comprises at least one layer.

According to a further aspect, the sports equipment is a golf club head cover. In other aspects, the sports equipment is a golf club bag, golf glove, or a sports equipment bag.

Other aspects of this invention relate to a golf bag including a housing having an exterior surface, wherein the housing defines a chamber configured for items, such as golf clubs, to be placed, and a base secured to the housing. A retroreflective material is connected to the housing and at least partially visible on the exterior surface of the housing. The retroreflective material is configured to create a different visual appearance from other portions of the exterior surface of the housing when exposed to a light source. The golf bag may further include any of the features of the sports equipment described herein.

Other aspects of this invention relate to a golf club head cover including an elongated flexible body having an exterior surface, and a hollow compartment configured to receive and cover a golf club. A retroreflective material is connected to the body and at least partially visible on the exterior surface of the body. The retroreflective material is configured to create a different visual appearance from other portions of the exterior surface of the body when exposed to a light source. The golf club head cover may further include any of the features of the sports equipment described herein.

Other features and advantages of the invention will be apparent from the following description taken in conjunction with the attached drawings.

### BRIEF DESCRIPTION OF THE DRAWINGS

To allow for a more full understanding of the present invention, it will now be described by way of example, with reference to the accompanying drawings in which:

FIG. 1 is a perspective view of an illustrative embodiment of a piece of sports equipment in the form of a golf bag according to aspects of the present invention;

FIG. 2 is a side view of the golf bag of FIG. 1;

FIG. 3 is a back view of the golf bag of FIG. 1;

FIG. 4 is a perspective view of an illustrative embodiment of a piece of sports equipment in the form of a golf club head cover according to aspects of the present invention;

FIG. 5 is a side view of the golf club head cover of FIG. 4;

FIG. 6 is a back view of the golf club head cover of FIG. 4;

FIG. 7 is a top view of the golf club head cover of FIG. 4;

FIG. 8 is a side view of an example embodiment of a golf club head cover in accordance with aspects of the present invention, under exposure from a light source;

FIG. 9 is a side view of the golf club head cover of FIG. 8, with broken lines indicating portions of a golf club in an interior hollow compartment of the golf club head cover; and

FIG. 10 is a schematic illustration of one example of retroreflective material that may be used according to aspects of the invention.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

The various figures in this application illustrate examples of sports equipment and other components according to this invention. When the same reference number appears in more than one drawing, that reference number is used consistently in this specification and the drawings refer to the same or similar parts throughout.

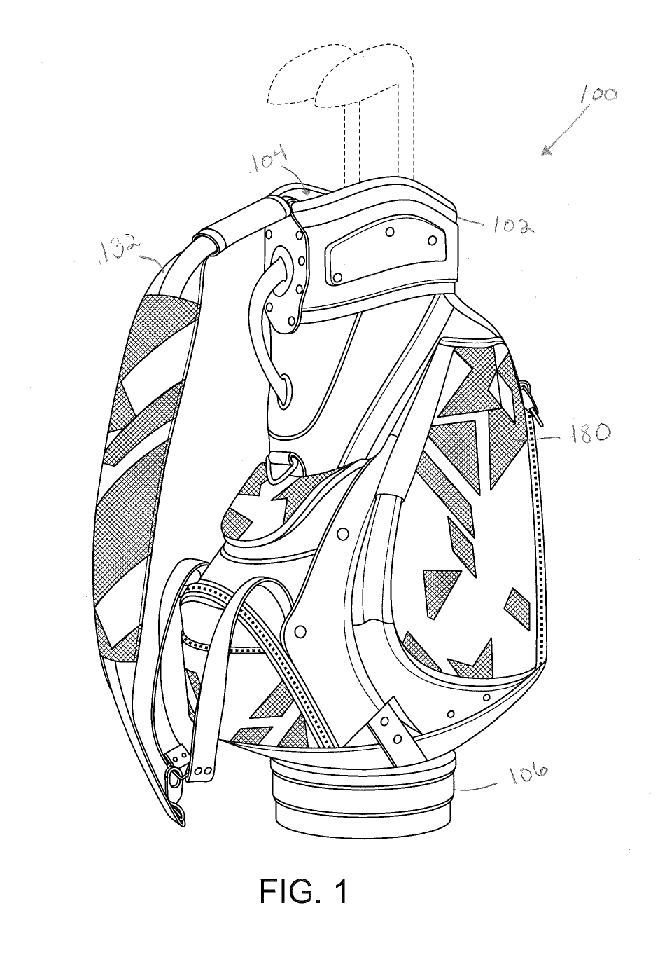

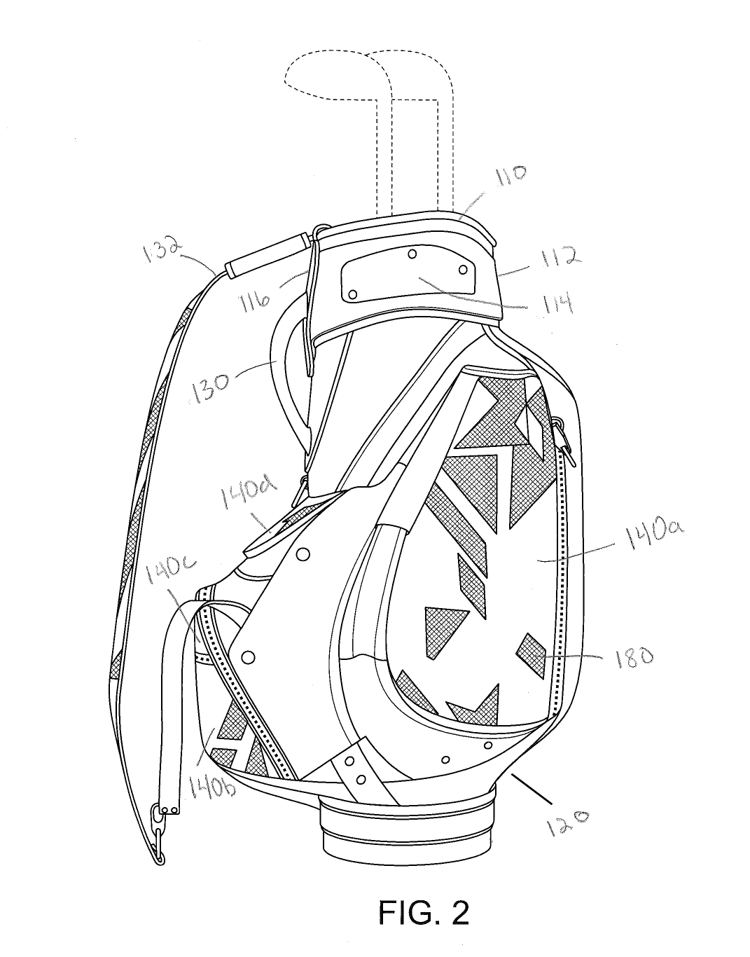

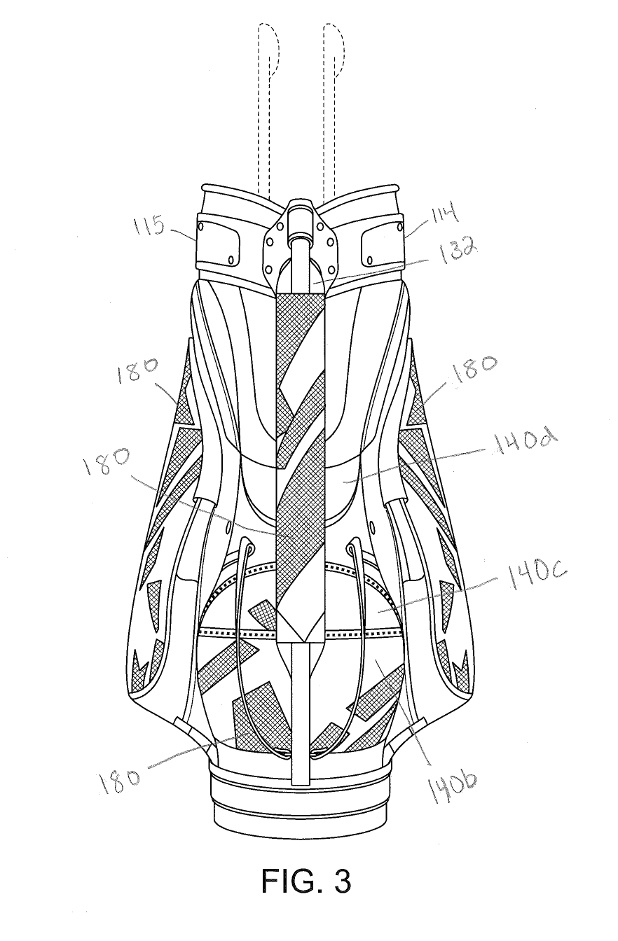

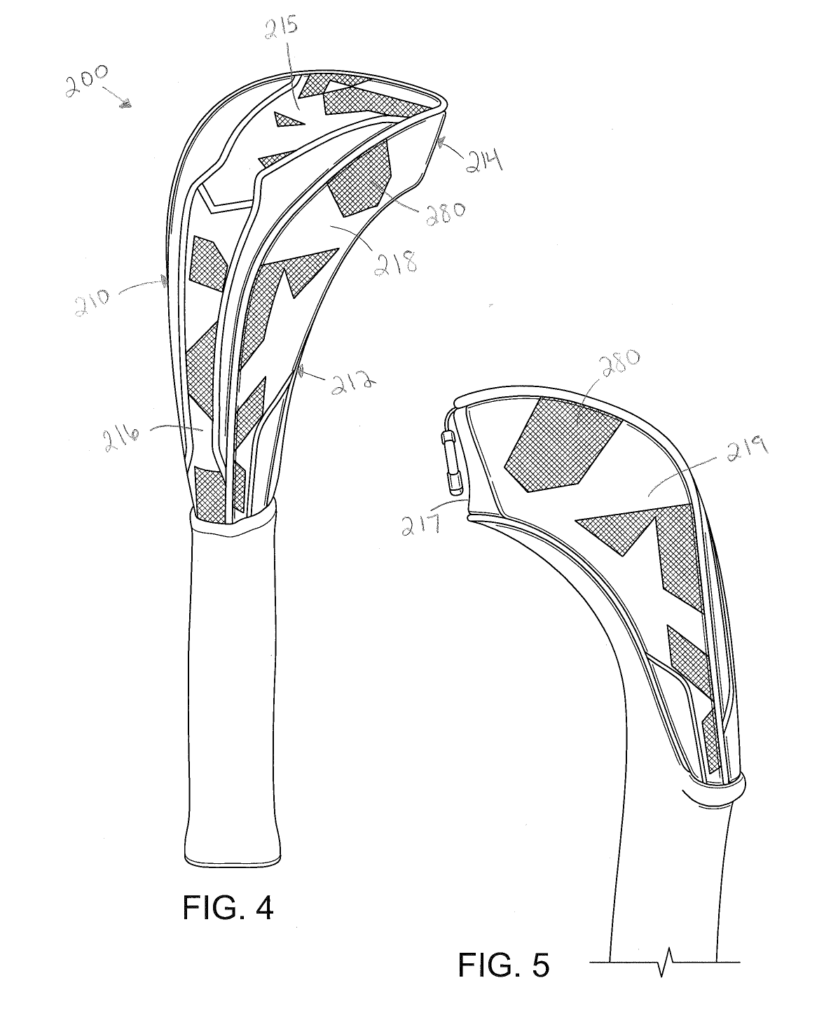

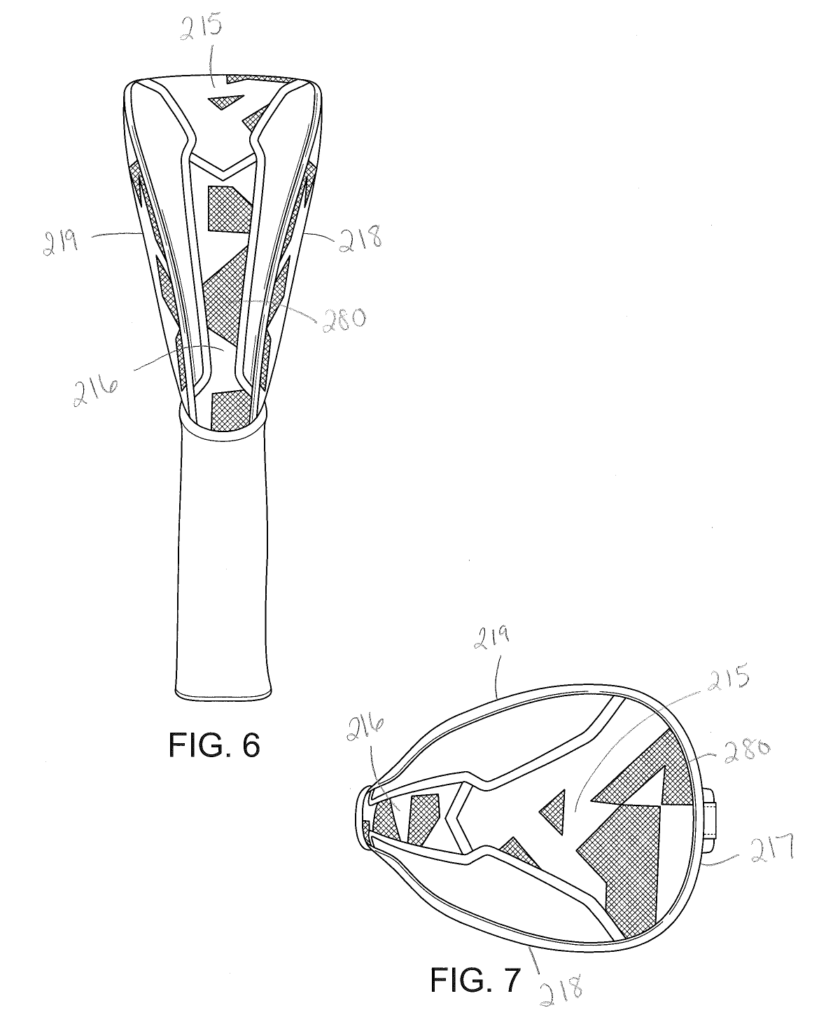

Example structures of sports equipment according to this invention will be described in detail below in conjunction with FIGS. 1-3, which illustrate a golf bag in accordance with at least some examples of this invention, and FIGS. 4-9, which illustrate a golf club head cover in accordance with at least some examples of this invention. It is understood that the aspects and embodiments described herein may be used with other types of sports equipment, including, without limitation, apparel (e.g., shirts/jerseys, pants/shorts, shoes/skates, hats/caps, gloves, socks, glasses, etc.), striking devices (e.g., bats, rackets, sticks, mallets, golf clubs, paddles, etc.), protective equipment (e.g., pads, helmets, guards, visors, masks, goggles, etc.), locomotive equipment (e.g., bicycles, motorcycles, skateboards, cars, trucks, boats, surfboards, skis, snowboards, etc.), other types of storage or transport equipment (e.g., boxes, bags, sacks, racks, etc.), balls/pucks for use in various sports, fishing or hunting equipment, and various other types of sports equipment.

Referring to FIGS. 1-3, one embodiment of an article of sports equipment in the form of a golf bag 100 in accordance with at least some examples of this invention is illustrated. The golf bag 100 generally includes a housing 102 defining a chamber 104 into which items to be carried, such as golf clubs, may be placed. A base 106 is secured to the housing 102 to provide support and a point of contact between the golf bag 100 and the ground. The base 106 may be arranged to allow the golf bag to stand up substantially vertically, and/or other structures may be provided (e.g., extendable legs, a flexible base member, etc.) to enable the bag 100 to be stood up in an angled manner.

Housing 102 is a substantially hollow structure with a generally elongate and tubular configuration for receiving golf clubs. Housing 102 is formed of a front portion 112, two side portions 114, 115, a back portion 116, an upper end 110, and a lower end 120. A variety of materials, textiles and the like may form and/or be provided on the exterior of the housing 102 and/or otherwise used in the golf bag construction. The golf bag 100 may further include any other components that may typically be included on golf bags. For example, a divider (not shown) may be secured at an upper end 110 of the housing 102 and may define a plurality of apertures that provide access to chamber 104 and help keep the clubs separated from one another. When in use, shafts of golf clubs extend through the apertures and along the longitudinal length of the housing 102. Heads of the golf clubs remain accessible and generally at the exterior of the golf bag 100. A divider may be used to organize and prevent damage to the golf clubs. In this regard, a divider may be formed of a polymer or other material and/or may have a foam and/or textile sheath to provide a yielding and protective surface for contacting clubs. A divider further may include a partition (not shown) that extends between a lower portion of the divider and base 106 to further segregate the volume within the housing 102 and separate the various clubs. Other types of dividing structures may be used in other embodiments.

Golf bag 100 also may include a semi-rigid frame 105 to provide a supporting structure that retains the generally elongate and tubular configuration of housing 102. The frame 105 may have the configuration of one or more shafts that extend along the front, back, and sides of housing 102. The frame 105 may be at least partially or completely internal within the structure of the bag in some embodiments. In the upper areas of golf bag 100, if desired, this frame 105 may be accessible and/or exposed and curved to define a handle 130 that assists with carrying golf bag 100 and may provide a point of attachment for one or more shoulder straps 132. In lower areas of the golf bag 100, the frame 105 may extend into the materials that form the exterior of housing 102. Alternatively, the frame 105 may be curved in the lower area in order to support the shape and limit collapse of the material elements that form pockets in housing 102. That is, the frame 105 may be curved to run adjacent to the exterior of housing 102, thereby providing a support structure that assists with retaining the shape of housing 102 or features engaged with the housing 102. Suitable materials for the frame 105 include a variety of polymer materials, graphite, wood, fiberglass, and metals, such as aluminum, as well as other examples. In alternate arrangements, the frame 105 may have the configuration of multiple stay rods. Other housing 102 and/or frame 105 structures are possible without departing from the invention, including conventional structures and/or constructions as are known and used in the art. The housing 102 also includes a covering 150 that may be substantially permanently affixed to the frame 105 and may be formed of fabric and/or other materials. The covering 150 of the golf bag 100 forms at least a portion of the exterior surface 170 of the golf bag 100. It is understood that the exterior surface 170 may include a single surface or a plurality of surfaces that may be exposed and/or visible from the exterior of the golf bag.

The golf bag 100 of FIGS. 1-3 also includes a plurality of compartments or pockets 140a-140d distributed around the housing 102. The pockets 140a-140d may vary in size and generally may provide a substantially enclosed region in which various golf accessories, such as golf tees, balls, towels, rain gear, range finders, and the like, as well as personal items, may be stored. For example, a golf bag 100, according to an embodiment of the present invention, can include a large pocket 140a inserted on the side 114 of the housing 102, and typically used for storing larger golf club accessories, such as covers or cleaning towels, and generally at least one or more other smaller pockets 140b-140d used to store golfing accessories such as golf balls or golf tees. The pockets 140a-140d generally are enclosed on at least one side by a zipper, a hook and loop fastener, a snap fastener, a tie fastener, or other type of fastener or closure system to prevent objects within the pockets 140a-140d from spilling out. In one embodiment, some outer surfaces of the pockets 140a-140d form portions of the exterior surface 170 of the golf bag 100.

An embodiment of the present invention, such as that illustrated in FIGS. 1-3, can enhance the functionality of both conventional and custom golf bags 100 by temporarily or permanently affixing a retroreflective material 180 onto at least a portion of the exterior surface 170 thereof. It is understood that the retroreflective material 180 may be affixed to the exterior surface 170 by forming the retroreflective material 180 on the exterior surface, forming the retroreflective material 180 on one or more intermediate components and connecting the intermediate component(s) to the exterior surface 170, and/or other techniques. The retroreflective material 180 may be engaged with or integrally formed with the housing 102 and at least partially visible on the exterior surface 170 of the housing 102. The retroreflective material 180 may be engaged with the housing 102 using any of the various known methods of attachment, such as stitching, adhesives, mechanical fasteners, etc. It is understood that such engagement may be surface-to-surface engagement with the exterior surface 170 of the golf bag 100. In some embodiments, the retroreflective material 180 may be removable from the golf bag 100. Alternatively, if desired, the retroreflective material 180 may be integrally formed as part of the structure making up some portion of the overall golf bag structure 100, such as formed in or on one of the pocket members 140a-140d, formed in or on the material and/or structures making up the exterior of the housing 102, etc. The retroreflective material 180 may comprise a base layer and a reflective layer. The retroreflective material 180 is preferably readily visible and preferably not readily removable, i.e., substantially permanently affixed in order to prevent inadvertent removal or destruction. For example, the retroreflective material 180 may form a portion of the covering 150 in one embodiment, rather than being attached in surface-to-surface contact to the housing 102. The retroreflective material 180 is configured to provide an aesthetic appearance in which the retroreflective material 180 appears to form a seamless, integral part of the golf bag 100.

The retroreflective material 180 may be located or arranged at any position on the exterior surface 170 of the golf bag 100. For instance, the retroreflective material 180 may be positioned on a lower portion of the golf bag 100, near its bottom. Positioning the retroreflective material 180 at a lower portion of the golf bag 100 may provide improved visibility when the bag 100 is in a substantially horizontal position, such as when it is being carried by a user. In another embodiment, the retroreflective material 180 may be arranged at a middle or upper portion of the golf bag 100, near its top. As yet additional embodiments, if desired, the retroreflective material 180 may extend essentially the entire length of the golf bag 100 and/or it may extend around the circumference of the golf bag 100. The location of the retroreflective material 180 may be selected such that the retroreflective material 180 can be readily visible to a user. The retroreflective material 180 of the illustrated golf bag 100 in FIGS. 1-3 is generally located on pocket members 140a-140d and strap 132. Other configurations are also possible.

The retroreflective material 180 according to an embodiment of the present invention can include any number of various types of designs imaginable. In the example arrangements shown in FIGS. 1-3, the retroreflective material 180 is arranged in one possible unique design. As shown in FIGS. 1-3, the retroreflective material 180 may have a unique or distinctive shape or form that can be readily used to assist the owner in readily identifying the golf bag 100, i.e., the retroreflective material 180 can function to allow the owner to easily and quickly identify the golf bag 100 among a group of others through visual recognition of the retroreflective material 180. The retroreflective material 180 may be visible on at least thirty percent of the exterior surface 170, or in other embodiments the retroreflective material 180 may be visible on at least fifty percent of the exterior surface 170.

The retroreflective material 180 designs may include indicium or various indicia, including but not limited to, one or more letters, numbers, symbols, images, and/or trademarks disposed on the exterior surface 170. The retroreflective material 180 may also form human-readable indicia or a pattern graphic. In addition, the retroreflective material 180 may take the form of a specific design such as the manufacturer affiliation, company logo, sports team name or mascot, or other designs as creatively desired.

Although the retroreflective material described above generally is shown as being integrated into the structure of a golf bag, in an alternate arrangement, the retroreflective material may be an add-on type accessory, e.g., that could be purchased separately from the golf bag (and indeed attachable to any desired object, not limited to a golf bag). In other words, retroreflective materials of this type may be attached to a golf bag (or to other sports equipment, such as a golf club head cover, etc.) as an after-market or other separate piece, e.g., using such known attachment means as hook-and-loop fasteners, retaining member structures, adhesives, and the like. It is understood that the retroreflective material 180 as described above with respect to FIGS. 1-3 and elsewhere herein may be utilized with any type of sporting equipment (including others described herein) in any of the manners and configurations described herein.

Referring to FIGS. 4-9, a golf club head cover 200 in accordance with at least some examples of this invention is illustrated. The golf club head cover 200 generally includes an elongated flexible body 210 defining a hollow compartment 220 configured to receive and cover a golf club 202. Body 210 is formed of a head portion 214 and a sleeve portion 212. In one embodiment, the head portion 214 and the sleeve portion 212 may form an L-shaped configuration. In some embodiments, the head portion 214 defines a head compartment 224 configured to receive and completely cover a golf club head 204 of the golf club 202, while the sleeve portion 212 defines a sleeve compartment 222 in communication with the head compartment 224 in which the sleeve compartment 222 defines an open end 232. The open end 232 allows passage of the golf club head 204 through the sleeve compartment 222 and permits a portion of the shaft 206 of the golf club 202 to be covered by the sleeve portion 212 once the golf club head 204 is fully disposed inside the head compartment 224. In some embodiments, the golf club 202 may be associated with at least one of a driver-type golf club, a wood-type golf club, an iron-type golf club, a hybrid-type golf club, or a putter-type golf club.

Referring to FIGS. 4-9, the flexible body 210 of the club head cover 200 further defines a top wall 215, a rear wall 216, a front wall 217, a first side wall 218, and a second side wall 219 that collectively define the hollow compartment 220. The club head cover 200 has an exterior surface 270 that may be formed by outer surfaces of a variety of components of the head cover 200. It is understood that the exterior surface 270 may include a single surface or a plurality of surfaces that may be exposed and/or visible from the exterior of the club head cover 200. The club head cover 200 including its exterior surface 270 may be made from a variety of materials, such as leather, synthetic rubber, neoprene, polyethylene, polyurethane, acrylonitrile butadiene styrene (ABS), plastic, fabric material, or combinations thereof, as well as other materials.

Referring to FIG. 9, the golf club head 204 defines a toe portion 205 and a heel portion 203 that fits within the head compartment 224 and corresponds to a first head end 260 and a second head end 262 defined by the head portion 214 when the golf club head 204 is disposed inside the head compartment 224. In some embodiments, the head compartment 224 increases in size from the second head end 262 to the first head end 260. In one embodiment, the head compartment 224 is wider at or proximate to the first head end 260 than at or proximate to the second head end 262.

Although FIGS. 4-9 illustrate golf club head cover 200 having a particular symmetrical configuration, the apparatus and methods described herein may include other symmetrical or asymmetrical configurations. For example, the club head cover 200 may have a circular configuration from the top view. In another example, the club head cover 200 may have a specific shape that fits a particular golf club head, such as the driver-type golf club head illustrated in FIG. 9.

An embodiment of a club head cover, such as that illustrated in FIGS. 4-9, can enhance the functionality of both conventional and custom golf club head covers 200 by temporarily or permanently affixing a retroreflective material 280 onto at least a portion of an exterior surface 270 thereof. The retroreflective material 280 may be affixed to the exterior surface 270 of a golf club head cover 200 as shown in FIGS. 4-9 in the same manner described above with respect to the golf bag 100 in FIGS. 1-3.

The location of the retroreflective material 280 may be selected such that the retroreflective material 280 can be readily visible to a user. The retroreflective material 280 of the illustrated golf club head cover 200 in FIGS. 4-9 is generally located on the top wall 215, rear wall 216, first side wall 218, and second side wall 219. The retroreflective material 280 may be located or arranged at any position on the exterior of the golf club head cover 200. For instance, the retroreflective material 280 may be positioned on a lower portion of the golf club head cover 200, near the sleeve portion 212. In an alternate arrangement, the retroreflective material 280 may be arranged at a middle or upper portion of the golf club head cover 200, near the head portion 214. Positioning the retroreflective material 280 at an upper portion of the golf club head cover 200 may provide improved visibility such as when it is fitted on a golf club that is in a golf bag. As yet additional alternatives, if desired, the retroreflective material 280 may extend essentially the entire length of the golf club head cover 200 and/or it may extend around the circumference of the golf club head cover 200. Other configurations are also possible.

The retroreflective material 280 according to an embodiment of the present invention can include any number of various types of designs imaginable. In the example arrangements shown in FIGS. 4-9, the retroreflective material 280 is arranged in one possible unique design. As shown in FIGS. 4-9, the retroreflective material 280 may have a unique or distinctive shape or form that can be readily used to assist the owner in readily identifying the golf club head cover 200, i.e., the retroreflective material 280 can function to allow the owner to easily and quickly identify the golf club head cover 200 among a group of others through visual recognition of the retroreflective material 280. The retroreflective material 280 may be visible on at least thirty percent of the exterior surface 270, or in other embodiments the retroreflective material 280 may be visible on at least fifty percent of the exterior surface 270.

Although the retroreflective material described above generally is shown as being integrated into the structure of a golf club head cover, in an alternate arrangement, the retroreflective material may be an add-on type accessory, e.g., that could be purchased separately from the golf club head cover (and indeed attachable to any desired object, not limited to a golf club head cover). In other words, retroreflective materials of this type may be attached to a golf club head cover (or to other sports equipment, such as a golf club head cover, etc.) as an after-market or other separate piece, e.g., using such known attachment means as hook-and-loop fasteners, retaining member structures, adhesives, and the like. It is understood that the retroreflective material 280 as described above with respect to FIGS. 4-9 and elsewhere herein may be utilized with any type of sporting equipment (including others described herein) in any of the manners and configurations described herein.

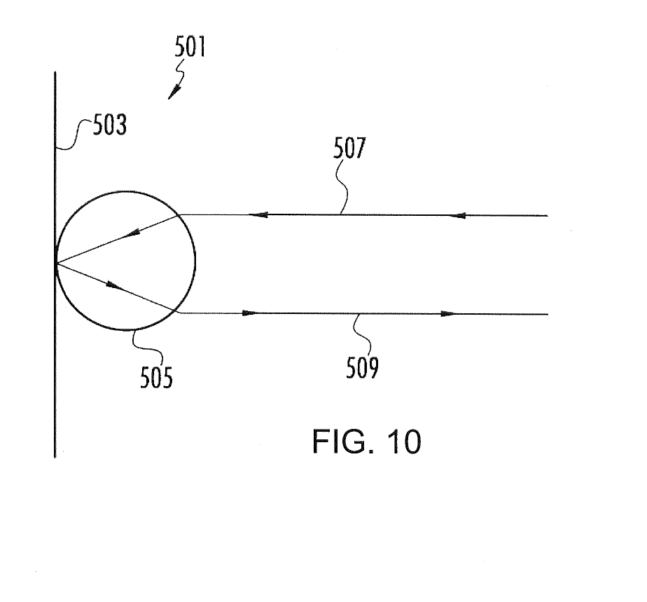

A retroreflective material is a material that reflects light back in the direction of its source. More particularly, the operation of retroreflectivity will be discussed briefly with reference to FIG. 10. As will be appreciated by those of ordinary skill in the art, materials typically will reflect in one of two ways. First, a surface may diffusely reflect incident light. That is, if incident light strikes a diffusive surface at a particular angle, the surface will reflect that incident light in multiple directions, and not produce a clear reflection of the incident light. Second, a surface may provide a specular or mirror reflection. With this type of surface, if incident light strikes the surface at a particular angle, the surface will reflect the incident light at the opposite angle. With retroreflective materials as described herein, however, the incident light is reflected in generally the same direction from which it originated.

In the embodiment illustrated in FIG. 10, the retroreflective material includes a mirrored layer 503 and a retroreflective sheeting layer 504 over the mirrored layer 503. The retroreflective sheeting layer 504 may be formed of a plurality of retroreflective bodies 505, which may take any of a number of different forms. For example, the retroreflective bodies 505 may be in the form of tiny cube or prism elements or transparent beads, such as the sphere 505 shown in FIG. 10. As seen in this figure, when an incident light ray 507 strikes the bead 505, it is reflected toward the center axis (perpendicular to the mirrored layer 503) of the bead 505. When the incident light ray 507 is then reflected from the mirrored surface 503, it exits the bead 505 in a direction generally parallel to that of the incident light ray 507. Thus, retroreflective materials will reflect incident light in generally the same direction from which it originated. Of course, there may be some deviation between the direction of the incident light ray and its corresponding reflected light ray. This deviation is referred to as the observation angle.

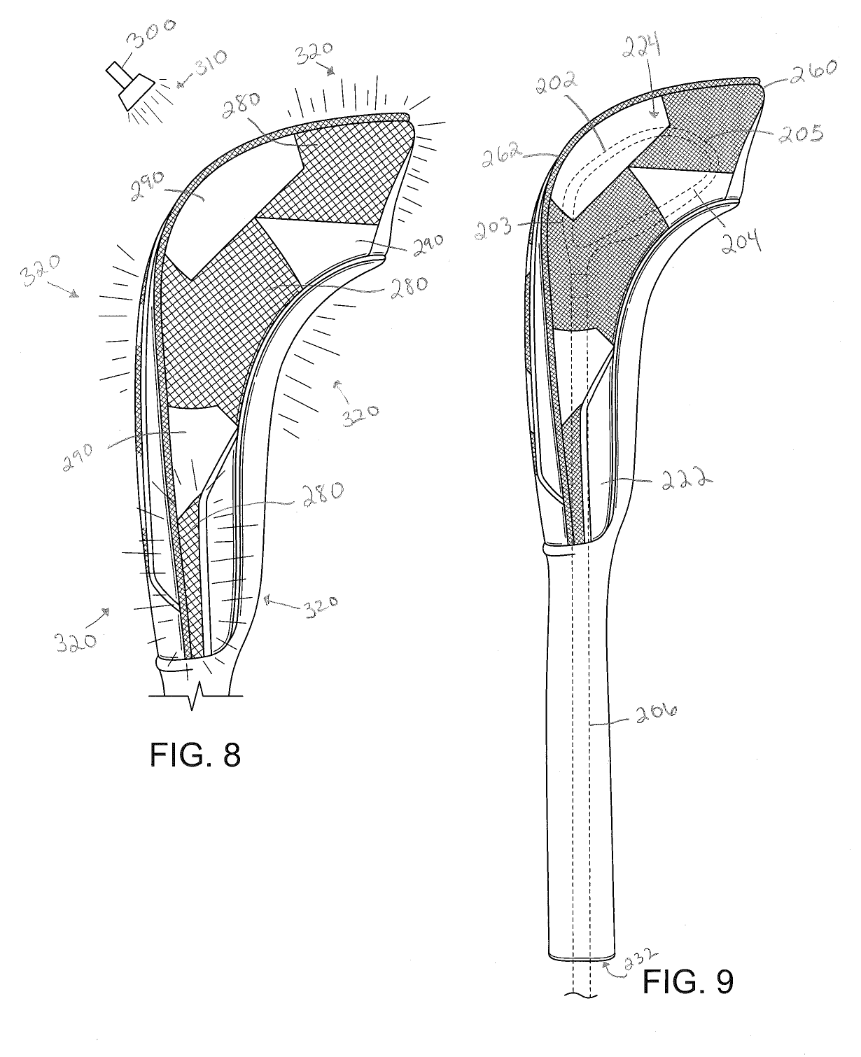

Returning now to FIGS. 1-9, the examples of sports equipment shown therein take advantage of the retroreflective material 180, 280. For example, as shown in FIG. 8, a light source 300 emits light directed at golf club head cover 200. In some embodiments, the retroreflective material 180, 280 may be configured to reflect light of high intensity. When a beam of incident light 310 is directed from the light source 300, the retroreflective material 180, 280 reflects the incident light 310 in a beam of reflected light 320. The direction of the reflected light beam 320 is back toward the light source 320. Because the light source user and other spectators are usually relatively close to the light source 300, it is within the observation angle for light reflected from the light source 300. Additionally, light from camera flashes will be reflected directly back toward the camera, making the retroreflective materials highly visible from the perspective of the camera. The light source 300 may also be a camera light or a flashlight.

Thus, the light from the light source 300 reflected by the retroreflective material 280 will create a different visual appearance from other portions of the exterior surface of the body. As will be appreciated by those of ordinary skill in the art, however, other observers standing outside of the observation angle may not view the reflected light 320 from the retroreflective material 280. Instead, to these observers, the retroreflective material 280 may be unnoticed or simply appear as a somewhat shiny mark. Moreover, because of the high reflectivity of the retroreflective material 280, it will be strongly distinguished from its surrounding background, such as the background provided by the matte material 290. The matte portion 290 may be partially visible on the exterior surface 270 of the body. This will assist observers in recognizing the retroreflective material 280 from its background.

The amount of light being reflected by the retroreflective material may vary based on the albedo, or reflection coefficient, of the retroreflective material. Albedo is the fraction of incident light reflected by a surface. As such, retroreflective materials having different albedos may provide different visual appearances from each other as well as from other portions of the exterior surface. The different visual appearances between retroreflective materials and other portions of the exterior surface are caused by the differences in luminance of each material. Luminance is the light observed from a retroreflective material. Total luminance is determined by brightness, amount and placement of retroreflective material, and position of the retroreflective material relative to the observer. Brightness is a term used to define the retroreflective performance of a material measured at specific angles. Retroreflective materials appear brightest to observers located near the light source. Observation angle is important because retroreflective light is returned as a narrow cone with the inner part of the cone being most intense. The farther the observer is from the reflective material, the smaller the observation angle becomes.

In general, retroreflective materials have a plurality of retroreflective bodies, e.g., glass beads or microprism/prismatic elements, as described elsewhere herein. These elements are built into retroreflective material and can be protected by a smooth top film. One type of retroreflective material is a sheet material comprising a plurality of retroreflective bodies sealed onto a base sheet layer. Such retroreflective sheeting is a flexible retroreflective material. In general, the retroreflective bodies consist of retroreflective glass beads, microprisms, or encapsulated lenses. These retroreflective bodies may be sealed onto a fabric or plastic substrate. Many different colors and degrees of reflection intensity may be provided by numerous manufacturers.

Several examples of different retroreflective materials and products that may be used with the invention are shown and described at http://solutions.3m.com/wps/portal/3M/en_US/ScotchliteReflectiveMaterial/Scotchlite/product-information/product-catalog/ and are incorporated herein by reference.

One example of a retroreflective material is transfer films, which are composed of retroreflective lenses bonded to a variety of heat-activated adhesives. Another example is fabrics composed of retroreflective lenses bonded to a variety of fabric backings. Other examples include trims composed of retroreflective lenses bonded to fabric backings. A further example is high gloss materials that are composed of microprisms bonded to a flexible, glossy, UV-stabilized polymeric film. They may be sewn or radio/high frequency (RF or HF) welded to compatible fabrics. High gloss films may also be screen printed, embossed or used as piping. Another example is pressure-sensitive adhesive (PSA) films, which are composed of retroreflective lenses bonded to a variety of PSA. Another example is graphic transfers that are made by screen printing an adhesive in reverse print onto the back side of a sheet of retroreflective lenses. Yet another example is inks that are composed of a water-based (latex) ink base combined with retroreflective lenses. A still further example is products that are composed of an encapsulated lens incorporated onto a backing such as a sewable or PSA backing.

Embodiments of the sports equipment as described herein provide many benefits and advantages over existing products. For example, sports equipment may have designs or logos on its exterior surface, thereby providing aesthetic appeal, identification means, and/or marketing means. Although such designs may exist on sports equipment, the designs are typically conventional and are accomplished by information/markings that retain a constant visual appearance, such as paint, dye, ink, stitching, patches, etc. Retroreflective material designs on sports equipment to reflect light and provide a desired visual appearance with the reflective parts of the design is a non-conventional unique design. Such a design may be aesthetically appealing and also may aid an individual in identifying ownership of his or her sports equipment when it is situated among others. Retroreflective materials may be an integral part of the overall design of the sports equipment. Another advantage of retroreflective material designs is the additional exposure of the sports equipment from a marketing perspective. The sports equipment may provide a location for a retroreflective material design to display certain indicia (e.g., advertising or other product information). For instance, a flash on a camera is often used when a photograph is taken of a professional athlete such that a high intensity light will shine on the athlete's sports equipment. Therefore, providing a reflective design on the sports equipment allows the reflective design to be visually apparent in such photographs. The reflective design may further be used to display and convey advertising, marketing, promotional, educational, or governmental information. Such designs are cost-efficient and are unique and appealing to consumers, as well as manufacturers, sponsors, etc.

While the invention has been described with respect to specific examples including presently preferred modes of carrying out the invention, those skilled in the art will appreciate that there are numerous variations and permutations of the above described systems and methods. Thus, the spirit and scope of the invention should be construed broadly as set forth in the appended claims.

What is claimed is:

1. An article of sports equipment comprising:
a body having an exterior surface; and
a retroreflective material connected to the body and at least partially visible on the exterior surface of the body, wherein the retroreflective material is configured to create a different visual appearance from other portions of the exterior surface of the body when exposed to a light source.

2. An article of sports equipment as claimed in claim 1, wherein the retroreflective material is visible on at least thirty percent of the exterior surface.

3. An article of sports equipment as claimed in claim 1, wherein the retroreflective material is visible on at least fifty percent of the exterior surface.

4. An article of sports equipment as claimed in claim 1, the body further comprising a matte portion, wherein the matte portion is at least partially visible on the exterior surface of the body.

5. An article of sports equipment as claimed in claim 1, wherein the retroreflective material is removable from the sports equipment.

6. An article of sports equipment as claimed in claim 1, wherein the retroreflective material is configured to reflect at least light of high intensity.

7. An article of sports equipment as claimed in claim 6, wherein the light of high intensity is selected from a group consisting of: a camera flash, a camera light, and a flashlight.

8. An article of sports equipment as claimed in claim 1, wherein the retroreflective material is a sheet material comprising a plurality of retroreflective bodies sealed onto a base sheet layer.

9. An article of sports equipment as claimed in claim 8, wherein the retroreflective bodies include at least one type selected from a group consisting of: retroreflective glass beads, microprisms, and encapsulated lenses.

10. An article of sports equipment as claimed in claim 1, wherein the retroreflective material comprises a base layer and a reflective layer.

11. An article of sports equipment as claimed in claim 1, wherein the sports equipment is selected from a group consisting of: a golf club head cover, a golf club bag, a golf glove, and a sports equipment bag.

12. A golf club bag comprising:
a housing having an exterior surface, wherein the housing defines a chamber with an opening, wherein the housing is configured to receive a plurality of golf clubs within the chamber by insertion through the opening;
a base secured to the housing; and
a retroreflective material connected to the housing and at least partially visible on the exterior surface of the housing, wherein the retroreflective material is configured to create a different visual appearance from other portions of the exterior surface of the housing when exposed to a light source.

13. A golf club bag as claimed in claim 12, wherein the retroreflective material is visible on at least thirty percent of the exterior surface.

14. A golf club bag as claimed in claim 12, wherein the retroreflective material is visible on at least fifty percent of the exterior surface.

15. A golf club bag as claimed in claim 12, the housing further comprising a matte portion, wherein the matte portion is at least partially visible on the exterior surface of the housing.

16. A golf club bag as claimed in claim 12, wherein the retroreflective material is removable from the golf bag.

17. A golf club bag as claimed in claim 12, wherein the retroreflective material is configured to reflect at least light of high intensity.

18. A golf club bag as claimed in claim 17, wherein the light of high intensity is selected from a group consisting of: a camera flash, a camera light, and a flashlight.

19. A golf club bag as claimed in claim 12, wherein the retroreflective material is a sheet material comprising a plurality of retroreflective bodies sealed onto a base sheet layer.

20. A golf club bag as claimed in claim 19, wherein the retroreflective bodies include at least one type selected from a group consisting of: retroreflective glass beads, microprisms, and encapsulated lenses.

21. A golf club bag as claimed in claim 12, wherein the retroreflective material comprises a base layer and a reflective layer.

22. A golf club head cover comprising:
an elongated flexible body having an exterior surface, the body defining a hollow compartment configured to receive and cover at least a portion of a golf club; and
a retroreflective material connected to the body and at least partially visible on the exterior surface of the body, wherein the retroreflective material is configured to create a different visual appearance from other portions of the exterior surface of the body when exposed to a light source.

23. A golf club head cover as claimed in claim 22, wherein the retroreflective material is visible on at least thirty percent of the exterior surface.

24. A golf club head cover as claimed in claim 22, wherein the retroreflective material is visible on at least fifty percent of the exterior surface.

25. A golf club head cover as claimed in claim 22, the body further comprising a matte portion, wherein the matte portion is at least partially visible on the exterior surface of the body.

26. A golf club head cover as claimed in claim 22, wherein the retroreflective material is removable from the golf club head cover.

27. A golf club head cover as claimed in claim 22, wherein the retroreflective material is configured to reflect at least light of high intensity.

28. A golf club head cover as claimed in claim 27, wherein the light of high intensity is selected from a group consisting of: a camera flash, a camera light, and a flashlight.

29. A golf club head cover as claimed in claim 22, wherein the retroreflective material is a sheet material comprising a plurality of retroreflective bodies sealed onto a base sheet layer.

30. A golf club head cover as claimed in claim 29, wherein the retroreflective bodies include at least one type selected from a group consisting of: retroreflective glass beads, microprisms, and encapsulated lenses.

31. A golf club head cover as claimed in claim 22, wherein the retroreflective material comprises a base layer and a reflective layer.
